(19) United States
(12) Patent Application Publication
(10) Pub. No.: US 2006/0271454 A1
(43) Pub. Date: Nov. 30, 2006

(54) Method of analyzing a sale process for a company

(76) Inventor: Steven R. Strom, (US)

Correspondence Address: GILBRETH ROEBUCK BYNUM DERRINGTON SCHMIDT WALKER &;TRAN LLP, FROST BANK BUILDING, 6750 WEST LOOP SOUTH, SUITE 920, BELLAIRE, TX, 77401, US

(21) Appl. No.: 11/137,059

(22) Filed: May 25, 2005

(51) Int. Cl. G06Q 40/00

(52) U.S. Cl. 705/35

(57) ABSTRACT

A method of evaluating the adequacy of the process to sell a company by evaluating competition, fairness, thoroughness, and good faith. The method comprises evaluating the potential purchasers of the entity, analyzing dissemination of information about the entity, appraising the time frames surrounding the merger and acquisition sequence, investigating the smoothness of the transaction, evaluating the facts surrounding the negotiation process, and assessing actions occurring during the execution of the merger and acquisition.

### BACKGROUND OF THE INVENTION

1. Field of the Invention

The invention relates generally to the field of evaluating the process for selling a company. More specifically, the invention is a standard method to evaluate the sale process for a company by applying a series of questions on specific aspects of the sale process.

2. Description of Related Art

There are several methods by which a company sells itself, a division of itself, or some of its property (i.e. real, tangible, or intellectual). For example, a public company can announce it has retained an investment bank and is “considering strategic alternatives”. The investment banker then solicits interest from potential buyers and selects the highest and best proposal. When a sale is consummated the board of directors may obtain a “fairness opinion” from a nationally recognized investment bank in order to determine the fairness, from a financial perspective, of the transaction. Another example is company in Chapter 11 seeking court approval to sell assets free and clear of liens pursuant to Section 363 of the Bankruptcy Code. In this example the sale may involve selection of a stalking horse bidder and then overbidding in an auction format in court. A third example of a different process involves owners of a private company selling the business to a loyal management team or heirs without a competitive process, using an investment banker to develop an opinion on value or asking a private equity firm their perspective on value and letting the buyer execute at this price. A fourth example is a parent company selling a small subsidiary and negotiating with only one or two parties with respect to purchase price. In each of these circumstances the company being sold is, in one-way or another, exposed to the market to determine value. The process of market exposure, however, differs in each case. The process of exposure and the resulting value assigned to the target business by market forces may be controversial. For example, creditors in a bankruptcy plan or asset sale may allege that the process was created to favor an inside buyer. In other circumstances, a board of directors may find themselves with “Revlon duties” requiring that the target company put itself up for sale and a hostile acquirer may contend they were discriminated against in the sale process. Unfortunately, a faulty sale process can lead buyers to an inaccurate level for “market value”, often implying a lower value for the business than might otherwise be obtained in a competitive process that is fair, thorough and conducted in good faith. Accordingly, parties alleging that the sale process provides an accurate measure of market value (or those attacking the validity and resulting value of such process) benefit from a standard methodology to evaluate a sale process.

### BRIEF SUMMARY OF THE INVENTION

Disclosed herein is a method of evaluating the merger and acquisition of an entity comprising, evaluating the potential purchasers of the entity, analyzing dissemination of information about the entity, appraising the time frames surrounding the merger and acquisition sequence, investigating circumstances surrounding the transfer of possession of the entity, evaluating the facts surrounding the negotiation process, and assessing actions occurring during the execution of the merger and acquisition. The entity can be a corporation or other business entity, real property, intellectual property, or any otherwise transferable asset or group of assets.

The step of evaluating the purchasers of the entity comprises determining the basis for selecting the original list of potential buyers, the treatment for parties expressing unsolicited interest, if a public announcement regarding the potential sale of the company, if the sale process known generally by industry participants, if the sale generally known by other investment bankers, if any logical potential buyers were not approached and why, if a Buyers' Log or comparable description of the timing and detail of the sale process with potential buyers existed, if the right individuals at the firms were approached, if sufficient follow up with the parties was conducted, reasons for logical parties not pursuing a transaction, the reason for passing over something the debtors could have rectified to make the process more competitive, what portion of potential buyers did the debtors obtain closure, and, if the results of the process be explained or reconciled.

The step of analyzing dissemination of information about the entity comprises determining if the information available to potential buyers was provided pursuant to a reasonable confidentiality agreement, if the information provided was adequate for a company to make an investment decision, if the information included a professionally prepared information memorandum, if the information easily accessible, if the information up to date, if potential bidders were informed of updates to the information, if financial projections were available and if the projections were realistic and if any critical assumptions were substantiated, if the information positioned the entity in a favorable light, if there was an opportunity to clarify questions and ask additional questions, if adequate information was available for parties to prepare schedules to a purchase agreement, and if risks to the transaction existed which could not be quantified.

The step of appraising the time frames surrounding the merger and acquisition sequence comprises determining, if adequate time was available to negotiate a confidentiality agreement, if adequate time existed to review the information available, if adequate time existed to prepare a bid, how the ti me allowed for the acquisition of the entity compared to acquisition processes for other companies in the same industry as the entity, how the timing of the acquisition of the entity compared to sales of similar bankrupt entities or sales of other entities with comparable issues and complexity, if any seasonal issues existed that could affect the marketing process, if cyclical issues existed that could impact ability of strategic buyers to consummate a transaction, if any part of the solicitation conducted during a period when other transactions in the marketplace were cancelled, if any parties in other similar transactions invoked material adverse change clauses to cancel their obligations, if any timing constraints existed that were beyond the control of the party selling the entity that drove the timing of the sale process.

The step of investigating circumstances surrounding the transfer of possession of the entity comprises determining if the seller of the entity can describe a way by which to deliver the asset to a potential buyer, if the acquisition process is likely to involve litigation, if process exists to deliver the asset more consensually, if circumstances exist that might limit the resources a potential buyer may spend investigating an acquisition, if there a reserve price for the entity and if it is elastic, if creditors or other constituencies were included in the solicitation process, if previous attempts to sell the entity had occurred and the results of those attempts, if the criteria for evaluating proposals was clear to potential buyers, the likely timing to consummate an acquisition, the level of intensity with which the seller of the entity negotiated the sale terms, if the market was concerned about the prospect of a bid by insiders, if the seller of the entity was able to satisfy market concerns about the process being a level playing field, if the seller of the entity had any negotiating leverage with potential buyers, the position that secured lenders had taken regarding a credit bid, and if critical aspects of the sale were present that were beyond the control of the seller of the entity.

The step of evaluating the facts surrounding the negotiation process comprises determining, if the sellers of the entity attempted to get parties to improve their proposals, if the sellers of the entity had time and leverage to negotiate the proposal, how many parties expressed interest in a transaction, what parties were involved in communicating with the prospective buyers, how many rounds of bidding occurred and did the proposals improve or not, how did the circumstances of the seller of the entity change during the solicitation process, if there was a belief by individuals in the industry of the entity that multiple parties were participating in the process, if any press speculation was evident regarding the identity or terms of potential buyers, how the information concerning the acquisition was administered by the sellers of the entity, if one of the buyers was an insider, if the value of the entity increased or decreased through the solicitation process, if individuals in the industry of the entity knew or expected insiders to be bidders, and if third parties expressed concern about the fairness of the process.

The step of assessing actions occurring during the execution of the merger and acquisition comprises determining, how rigorous was any follow-up with buyers by the sellers of the entity, how prompt were responses for additional data made, how knowledgeable were the professionals conducting the sale process regarding acquisitions, industry, and transaction specific issues, could the results of the acquisition be reconciled, if an Information Memorandum was prepared, was it professionally prepared, were parties conducting the process able to adapt to market and other changes, were the parties who conducted the process generally perceived to be trust-worthy and working to explore the highest and best proposal, and how much the parties soliciting, structuring and negotiating the transaction devoted time and attention to each particular buyer.

### DETAILED DESCRIPTION OF THE INVENTION

The evaluation of a sale process is necessary in situations where the economic beneficiaries of a sale or other party impacted by the value of a sale seek to contest or affirm the results of the value derived from the sale process. An example of the application is a situation where a bankruptcy court judge, creditors committee, board of directors or other party is trying to determine whether or not the sale process was a good faith effort to expose the target company to the market for valuation and specifically whether or not the price derived from such a process is a true indicator of “market value”. The present method refers to as adequate a sale process that yields a value that is a meaningful indicator of market value.

A sale process is typically conducted in order to determine the market value of a company by exposing the company to market. Typically, an investment banker will conduct a solicitation of offers from interested parties. If the process yields an accurate market value for the target company, the process is said to be adequate. There are at least four criteria to determine whether a sale process is adequate:
i. Fairness (e.g. did all participants compete on the same basis?);
ii. Thoroughness (e.g. would further exposure to the market likely lead to a significantly different transaction value or structure?);
iii. Competition (e.g. was there competition amongst the various buyers or other benchmark?); and,
iv. Good faith (e.g. did the sellers try to maximize value?).
   Each of these criteria is necessary for a sale process to be adequate. The criteria can be evaluated by answering a series of questions concerning the sale process. The present method considers the following categories of questions: audience, information, timing, transfer, negotiation, and execution. Tactically assessing the facts and circumstances of the sale process by asking questions in these categories enables the user to gain insight into the criteria for adequacy and make a determination as to the overall adequacy of the sale process.

A. Audience

The audience category describes who is approached as a potential buyer of the target company, i.e. the list of potential purchasers of the company being sold. Answers to the following questions can help determine if the appropriate audience was addressed.

1. What was the basis for selecting the original list of potential buyers?

This inquiry can reveal if a good faith and thorough effort was made to identify and solicit purchasers who could reasonably be expected to consider consummating a purchase of the target and would foster competition. Good faith could be indicated by inclusion of bidders who may terminate employees or shut down facilities or are otherwise controversial. The number of buyers considered may measure thoroughness. Typically, the sale of a company involves the direct solicitation of potential purchasers. A list of potential purchasers is usually developed by the seller's investment banker and is formulated by researching companies that have similar operations to the target, a strategic fit with the target, or otherwise has considered or will consider acquisitions with the characteristics of the target entity. Investment bankers also develop the list of buyers from their experience and databases on merger and acquisition activity and participation in an industry. Choosing potential purchasers who have no involvement in the particular industry of the target would probably not be productive. For example, approaching a group of consumer product companies about the acquisition of a steel company might indicate problems with the audience being pursued as buyers and lead to the conclusion that the results of such a process are flawed.

2. What was the treatment for parties expressing unsolicited interest?

Occasionally, parties not identified upfront as potential buyers of the target may be otherwise made aware of a transaction opportunity and express interest in participating. Sometimes these parties are legitimate buyers and sometimes they are not. But the buyer needs to address these “reverse inquiries” in order to ascertain whether the party expressing an interest could possibly complete a transaction. Here the question is asked if legitimate unsolicited inquiries were treated in an accommodating fashion or not. This query can ascertain if any bias on the part of the seller for or against certain purchasers is present i.e. fairness and whether competition was encouraged.

3. Did the target make any announcement regarding the potential sale of the company?

This portion of the analysis examines the publicity of the sale. Publicity may result in greater “reverse inquiry”. While the absence of an announcement is not determinative of a flawed sale process; it can be an indicator that there was diminished competition or the process was otherwise inadequate when viewed in combination with other evidence. Sometimes the target company will meet with several investment banks or the intermediaries to understand its strategic alternatives or might issue a press release that it is “exploring strategic options”. The venue such publications range from major newspapers of record to industry and trade journals. However, these publications may only allude to the prospect of a sale. Research analyst reports may also be considered in determining the market's understanding of whether a company is for sale.

4. Was the sale process known generally by industry participants?

The more parties that know and can compete, even as “reverse inquiry” buyers, the more likely there will be competition to buy the target company and the greater pressure there will be for the target to conduct sale process that is a fair, thorough and in good faith.

5. Was the sale generally known by other investment bankers?

For the same reasons the thoroughness of a transaction can be assessed based on the knowledge of industry participants who aware of the sale, the volume of investment bankers who know about the transaction can indicate to a skilled analyst whether or not a thorough process has been conducted. Frequently, investment bankers not retained by the target company may also solicit interested buyers in hopes of providing advisory or financing services to potential bidders. This can serve to foster competition by adding thoroughness.

6. Were any logical potential buyers not approached and why?

Logical buyers include competitors of the target company as well as a buyer with potential synergies or cost savings thru consolidation with the target. Sometimes management of a business does not want to be purchased by a competitor simply because current management may be replaced or demoted after such a sale. In other circumstances, confidentiality and potential business interruption concerns may be voices as reasons to avoid negotiations with competitors. Moreover, the absence of logical potential purchasers may indicate a purposeful avoidance of knowledgeable purchasers who would be more likely to pay a fair purchase price.

7. Is there a Buyers Log or comparable description of the timing and detail of the sale process with potential buyers?

Having a detailed log listing potential buyers enables third parties to readily analyze the timing, the buyers who were approached and other relevant issues in a sale process. Reviewing the log of buyers provides insight into the competitiveness and thoroughness of the process. In a process that is likely to be contested, most target companies should insist on a buyers log to document the timing of the process and parties approached.

8. Were the right individuals at the firms approached?

Although a particular company had been contacted regarding purchase of the target, the “right” individual within the purchaser's organization must also be contacted to qualify as a legitimate contact thereby indicating a thorough transaction process. The right individuals typically are senior executives, such as the chairman, CEO, CFO, or head of corporate development/acquisitions. In contrast, a flawed process may involve approaching an operating level manager whose job could be lost in a merger or a person not able to make an acquisition decision, for example the director of shareholder relations.

9. Was there sufficient follow up with the parties?

Follow up includes the interactions with potential buyers after the initial solicitation of interest. The intent of this line of questioning is to determine if buyers were treated fairly (i.e. was any favoritism shown and if so, why), to determine if the seller exhibited a good faith effort to encourage and facilitate reasonable information requests of potential purchasers and to determine thoroughness (i.e. how hard did the seller try to get a purchaser to bid on the target). Follow up with all buyers usually indicates a process is thorough. A consistent pattern of reasonable follow up with each potential purchaser that would encourage them to prepare and submit a workable bid would be indicative of a good faith effort, and fairness in the sale process. Unexplained variances in the level of follow up between the purchasers might indicate that the process is flawed.

10. For parties not pursuing a transaction what was the reason?

A purposeful act or purposeful inaction on the part of the seller with respect to one or more potential purchasers that discouraged the originally solicited buyer from further participating in the process could indicate that the seller did not want certain purchaser(s) to participate in the process. On the other hand, there may be a legitimate reason why the potential purchaser elected to withdraw from the process. An example of a legitimate rationale for opting out of the process is that the prospective buyer decided their existing business did not have a strategic fit with the target. Reasons that could raise suspicions of good faith would be the buyer did not believe the process would result in a sale even if they were the highest bidder or the seller cannot tell buyers the relevant information about its business. If the seller does not know what its doing in the sale process, buyers are less likely to commit resources to investigate a transaction.

11. Was the reason for not pursuing an acquisition of the company something the debtors could have rectified to make the process more competitive?

Sometime a seller cannot answer meaningful questions, in the example of the sale of a technology company in conjunction with pending litigation regarding the ownership of the target's patents. The seller may be unable to provide an educated opinion concerning the outcome and ramifications of the litigation. Any potential buyer would likely apply a discount for this uncertainty or chose not to participate as a buyer. In an example concerning a manufacturing company—buyers want to understand the pension obligations of the company in more detail and the seller refuses to provide detailed actuarial data to buyers. This would be an example of critical information in the seller's control they are not providing to potential buyers. The point of this question is to identify why buyers did not proceed to make a bid and understand if it was a factor that the seller could have influenced or was out it its control. This speaks especially to the fairness and good faith efforts of the seller.

12. With what portion of potential buyers did the debtors obtain closure?

In the context of the sale process, closure is accomplished when the seller has received a definitive answer from solicited potential purchaser either in the form of an actual bid or made aware that the solicited party has decided to pass on the opportunity and why declined. The actual percentages indicating a thorough process are dependent on the particular industry, the number of solicitations, and other circumstances. Those skilled in the art would be able to ascertain the thoroughness for each specific situation.

13. Can the results of the process be explained or reconciled?

This portion of the audience inquiry considers if an unexpected situation may skew the answers of the other questions. For example, if the target company were in an industry that was suffering from an economic downturn, interest in the purchase of that property might be lower than would otherwise be expected and thereby indicate lack of thoroughness or good faith in the process despite the.

B. Information

The information category of questions examines the information prepared by the seller and made available to each potential purchaser. Information provided to each prospective buyer that accurately reflects all aspects of the target company, both good and bad, would be an indicator of fairness, good faith and thoroughness. The following questions are provided as a guide to determine if the correct and necessary information was provided to the purchasers.

1. Is the information that was made available to potential buyers pursuant to a reasonable confidentiality agreement?

Most potential purchasers understand and appreciate the need for reasonable confidentiality agreements in the sales process and would likely agree to the terms of the agreement. However an overly broad and overreaching confidentiality agreement might make otherwise interested purchasers hesitant in pursuing the purchase thereby discouraging participations. As mentioned above, unnecessarily limiting potential purchasers is generally an indicator of an inadequate sales process.

2. Was the information adequate for a company to make an investment decision?

This question checks for thoroughness of information and is meant to characterize some of the other topics in this section. Purchasers of a large target company, require careful study of all facets of the business. A meager information package can often provide a disincentive for the reasonable purchaser to continue with the sales process. Specific information provided by sellers in a good faith process typically includes: projections, balance sheet and off balance sheet liabilities, material contracts and customers, critical vendors and suppliers, detailed cost and revenue information, and title analysis of assets owned/leased/encumbered, management and labor issues assessment, among other things.

3. Was there a professionally prepared information memorandum?

This question addresses the content of the information memorandum or other materials supplied to buyers and can be used by those skilled in the art in determining the good faith effort and thoroughness of the sales process.

4. Was the information easily accessible?

More easily accessible information enables potential purchasers to evaluate a purchase and determine if it is something that meets the needs and or mission of their business. Online and electronic data rooms, providing access to volumes of relevant data on the target company, with access limited to qualified buyers (who have executed a confidentiality agreement) are becoming more prevalent and ease administrative burdens of copying for both buyers and seller. Easier access to information generally supports the thoroughness, fairness and good faith elements.

5. Was the information up to date?

Outdated or stale information that failed to properly reflect the current state of the property might discourage potential purchasers from electing to pursue the transaction, result in diminished competition, and indicate a lack of thoroughness, good faith, or fairness. A reduced number of potential purchasers that engage in the sales process can reduce the ultimate sales price and enable an insider to purchase the property at a reduced price. Use of misleading or otherwise unsubstantiated projections could also result in improper value being applied by buyers.

6. Were potential bidders informed of updates to the data room?

The data room contains all salient information that a potential purchaser may want to reference in deciding whether or not to purchase the property and is typically located offsite from the sales property. Thus any updates to the information stored in the data room would be of great interest to serious potential purchasers. As such, informing all purchasers of the updates also reflects fairness and good faith.

7. Were there financial projections?

Assuming the target company produces cash flow, indicators of future cash flows would be an important piece of information desired by likely purchasers. Thus the lack of these projections might be evidence of a process lacking good faith or thoroughness.

8. Are the projections realistic and are critical assumptions substantiated?

While evaluation of these projections is somewhat subjective, reasoned opinions of how realistic they are can be developed by experts and presented to the fact finder forevaluation. Some additional questions falling under this heading might include: (a) what is management's history of making or missing projections and what caused previous variance? (b) What experience did the overall industry have on making or missing projections? (c) Do the projections imply appropriate industry metrics? Revenues should track to an industry metric such as bill per meal; win per slot machine per day, sale price per ounce of gold. (d) Do capital expenditure projects provide industry normative returns? (e) How do projections prepared by management compare with assumptions used by third parties, such as research analysts, industry consultants, competitors, and other sources? (f) Are the projections mathematically correct and/or is there double counting of certain items? These questions address the thoroughness and good faith aspects of the projections.

9. Was the business positioned in a favorable light?

This question focuses on the presentation and packaging of information provided to the potential purchasers, i.e. is the information content and presentation enticing or discouraging to buyers. For example, if the information identifies growth opportunities, presents ways to improve the business, or highlights any competitive advantage the business enjoys—this more than likely entices interest in the purchase of the property and fosters competitiveness. Conversely if the information focused on the negative aspects of the property, this obviously would be somewhat discouraging to potential buyers. Undue discouragement is a factor that would indicate a lack of good faith and inadequate process, manifesting itself in reduced competition.

10. Was there an opportunity to get clarification and follow-up questions answered?

Here again the inquiry focuses on the ability of the potential purchaser to acquire information regarding the property to be sold. Instances of free flowing readily available information are indicative of good faith and thoroughness.

11. Is there adequate information available for parties to prepare schedules to a purchase agreement?

Quite often the sale of a company is made up of multiple components that the buyer must be aware of before submitting his or her purchase agreement. These components are usually references by buyer and seller in a stock or asset purchase agreement that covers assets and liabilities included and excluded in the deal and specific representations and warranties concerning the sale and the companies involved. For the process to be fair, all potential buyers need to be bidding with the same access to information. To compare values provided by various buyers, bids need to reflect the same information and have similar terms or otherwise be reconcilable, subject to adjustment. Failure to provide information for the relevant schedules can indicate lack of fairness and good faith.

12. Were risks to the sales transaction present that could not be quantified or otherwise meaningfully evaluated?

Asking this question might explain why sales solicitations of the target company were poorly, in spite of a good faith, fair and thorough effort to shop the business. Examples of such risk include the threat of regulatory change and its impact on the target company. For example, when selling a casino in one state, the value of the target could be impacted by legislative moves towards legalizing gambling in a major metropolitan area of an adjoining state.

C. Timing

Analyzing the timing of the sales process and the timing of some of the steps of the sales transaction can ferret out some instances of unfair dealings on the part of the seller. The following questions examine the timetable of the entire sales process by analyzing the incremental timing of some of the individual steps.

1. Was there adequate time to negotiate a confidentiality agreement?

A determination if adequate time was available to negotiate a confidentiality agreement is dependent upon the circumstances of the sale itself. However it will be appreciated that those skilled in the art are capable of ascertaining if the allotted time was adequate. If adequate time was not allowed for this negotiation, it might indicate that the seller was trying to avoid dealing with that particular potential purchaser and indicate a flawed process that cannot be depended on to provide a relevant indication of market value.

2. Was there adequate time to review the information available?

This inquiry is very similar to the question of the time to negotiate a confidentiality agreement in that the determination of adequate time is circumstance dependent and that a lack of adequate time might be indicative of a lack of good faith, fairness or thoroughness

3. Was there adequate time for the buyer to prepare a bid and interested party or sellers to review bids?

In order for a reasonable bid to be prepared that satisfies a fairness inquiry, a certain amount of time is required likewise for review of bids. The amount of time required depends on the facts and circumstances of the particular bid, but can be determined by those skilled in the art. Adequate time ensures competitiveness can occur.

4. What was the time allowed for this process versus the merger and acquisition process for other companies in the industry of the target?

Merger, acquisition and divestiture process timetables are often similar within a given industry. Some industries have copious amounts of acquisition activity that are efficiently transacted by leveraged buy out firms, examples include natural gas distributors, video store chains and cable systems. Other businesses however require longer time frames for the same process, such as industries where more parties may be involved in completing a transaction, including labor unions or regulatory bodies. While this is a fact dependent inquiry, qualified analysts are capable of ascertaining if the time of the overall process comports with the time of target companies in the same or similar industries. This can be used as a benchmark to evaluate the good faith and thoroughness of the seller's process.

5. What was the timing of this process versus those for other target companies in similar situations (Chapter 11, distress or non-distressed) with comparable issues and complexity?

This is another benchmark analysis useful for determining if a sales process occurs within a reasonable amount of time. If a sale were to occur too quickly, likely purchasers may not have sufficient time in order to analyze the situation and decide if such a purchase would be beneficial. Conversely, if the time of a sales process exceeded an expected time frame, potential purchasers might become less inclined to participate in the transaction and therefore disengage themselves.

6. Were there any seasonal issues that could affect the marketing process?

The purchase activity of some industries cycles could impact the sale price or timing of the property if it is in a seasonally dependent industry. For example, most boats are sold to dealers at trade shows early each year. The manufacture then makes the boats and delivers them to the dealers who sell them in late spring or summer. Buyers would want to position the new company's products prior to the boat shows. Otherwise, they are buying a business with already booked revenues for the current year and cannot manage new products for a considerable period. Considering the seasonal issues a company faces in the context of a sale can help reconcile the results of a sale process.

7. Are there cyclical issues that could impact ability of strategic buyers to consummate a transaction?

An industry downturn may adversely impact the financial wherewithal of virtually all buyers. For example, in the steel industry, there have been periods when the preponderance of transactions was conducted through Chapter 11 plans and asset sales. The logical strategic buyers were experiencing poor performance for the same reasons the target companies were for sale. Understanding the industry cycle can provide insight into the good faith, fairness and thoroughness of a sale process as well as the ultimate determination of whether the price derived through sale is in fact market value.

8. Was any part of the solicitation conducted during a period when other transactions in the marketplace were cancelled?

Cancelled transaction could be due to a sudden downturn in the economy due otherwise unpredicted events such as the Sep. 11, 2001 terrorist attacks in the United States. Such a situation can mean that soliciting buyers is not likely to yield meaningful results. The market is effectively closed. This is another inquiry that can explain an otherwise unreasonable sales price but may indicate inadequacy of process to reflect true market value of the target.

9. During the process, did any parties in other similar transactions invoke material adverse change clauses to cancel their obligations?

This is a follow up question to asking if other transactions similar to the one at hand were cancelled. Invoking a material adverse change indicates either change in market conditions (e.g. Sep. 11, 2001), change in industry conditions (nationwide strike in an industry) or change at a company (factory breakdown and work stoppage). Also, parties may invoke a material adverse change and use this as a reason, real or not, as an excuse to back out of a commitment to complete a transaction. This may result in diminished competition and depending on the circumstances, diminished good faith.

10. Were there timing constraints beyond the debtor's control that drove the timing of the sale process?

Examples of some of the timing constraints considered here include regulatory timing and financial. Here again, the focus with this particular question is to see if some external factors might have affected the sales process that might have to be accounted for in evaluating the adequacy of the overall process.

D. Transfer

In some instances, as reflected in the questions listed below, some difficulties may be present that can hinder the actual transfer of the target company to the purchaser. However these difficulties can often be overcome with some effort on the part of the seller or buyer. In a situation lacking good faith or thoroughness the seller may present information focusing on the difficulties without divulging how these difficulties might be overcome. This would discourage a vigorous bidding by all prospective purchasers who are not aware it is possible to overcome these difficulties. The following questions can elucidate the issues that may block the transaction and what reasonable steps can be taken to circumvent any such impasse.

1. Can the debtors describe a way by which to deliver the asset to potential buyers?

This question seeks to determine if the seller has made a good faith attempt to circumvent the aforementioned obstacle of a smooth sale, thereby providing some evidence that the seller has no buyer preferences. An example of a good faith attempt might occur if the seller can develop a plan to cram down a specific class of creditors in a bankruptcy sale plan or to seek a court order to circumvent a shareholder agreement). A sale process may lack good faith if the seller cannot design or structure a transaction and develop some consensus in which to transfer the property.

2. Is the acquisition process likely to involve significant litigation?

Acquisitions in bankruptcy usually involve litigation by a creditor or equity committee. Other non-bankruptcy sales may involve antitrust litigation or tortuous interference claims by a jilted buyer. Fairness and good faith in the situation depends on the parties to the litigation and other factors. A potential buyer could use its litigation against the target as a method to scare off other bidders and minimize competition. Third party litigation may deter bidders to the extent they do not understand it. A good faith effort on the seller's part often requires demonstrating a way to solve these issues as part of a sale of the target.

3. Is there a process to deliver the asset more consensually?

This question investigates if the seller has opted for a reasonable transfer thereby making the acquisition more attractive to all prospective purchasers. One example of a more consensual transfer might be a pre-negotiated chapter 11 plan where creditors agree on a plan to sell the assets of the property to the buyer.

4. Are there circumstances that might limit the resources a potential buyer may spend investigating an acquisition?

The answer often exhibits the reasons for the amount and type of competition in a process For example, the most likely buyer could have been resource constrained because at the time of the target's auction the likely buyer was closing on another acquisition and lacked the “bandwidth” to pursue multiple acquisitions simultaneously.

5. Is there a “reserve price” and is it realistic?

If the seller communicates it has unrealistically high expectations, buyers probably will be less included to devote time investigating the purchase of target. If the price is too low they may view the opportunity with skepticism. However, buyers would more likely be enticed with too low of a reserve price rather than too high. Usually the seller sets the reserve price, but sometimes (for example in the sale of a distressed business or company in Chapter 11) creditors would rather own the target company themselves than obtain take a recovery less than their reserve price.

6. Were creditors or other constituencies included in the solicitation process?

Often when selling a distressed company, members of the creditor class who will are apt to receive only a fraction of what is owed to them participate in the sale process to observe and attempt to negotiate a better purchase price. This added scrutiny reduces the likelihood of financial mischief and is often an indicator of good faith. Other constituencies consulted on the sale process could be a union, bank lender, preferred stockholder or others consulted on a sale. Specifically these are parties that could otherwise upset or delay a sale.

7. Has the company been shopped before and what happened if it was? If the target company was previously put up for sale it is likely a transaction was not completed. Understanding why the previous sale was not completed can be helpful to those skilled in the art in determining how the target's sale process will be perceived the second time around.

8. Are the criteria for evaluating acquisition proposals clear to potential buyers?

These criteria are usually highest and best offer (actually “bid”), where highest is measured as economic consideration or value. Cash is easy to value but if securities are offered as consideration investment bankers will usually analyze value of various proposals. Determining what is “best” is often a more subjective task. For example, “best” may include a settlement with labor or provide certainty to other constituencies in a transaction. Clear communication of the rules for evaluating higher and better (or whatever criteria are applied) are indicators of a competitive and good faith effort. Communicating the common criteria equally to all participants is an indicator of fairness.

9. What is the likely timing to consummate an acquisition?

Timing to consummate purchase can be important to buyers, especially in an uncertain environment. Unnecessary delay between selection of winner in an auction and consummation is an important demonstration of good faith and thoroughness. Similarly, fairness issues need to be considered if timing to close is different for different parties. This also impacts the criteria of competitiveness.

10. What was the level of intensity with which the debtor negotiated the sale terms?

A highly intense series of negotiations in a sale process generally fosters competition indicate good faith a more thorough process and supports the conclusion that the process yields a true indicator of market value. On the other hand, a lackadaisical process where the seller/agent did not follow up promptly with buyers or was negative on the process is flawed and cannot be relied on to provide a meaningful view of market value. 11. Was the market concerned about the prospect of a bid by insiders?

As is well known, evidence of concern in the market about insider bids, even if unfounded, would chill competition by buyers for the target and likely depress value of bids by third parties. Affirmative responses to this question would cast serious doubt on the good faith efforts of the seller.

12. Was the seller able to satisfy market concerns about the process being unfair?

Concerns about fairness or good faith process can emanate from the possibility of an insider bid who has an advantage knowing what other parties were bidding and the bid amounts. To mitigate insider bids, some sellers can establish independent committee that evaluates bids and run the sale process. Thus sellers taking such action would be an indication of a good faith effort and fairness to non-inside bidders.

13. Did the sellers have any negotiating leverage with potential buyers?

The knowledge of negotiating leverage on the part of the seller enhances their selling position, which can be an indicator of an adequate sales process. Examples of limited negotiating leverage might include a company with dwindling financial resources or when only a few potential purchasers are pursuing the purchase. Exercising negotiating leverage can be viewed through competition among buyers.

14. What position have secured lenders taken regarding a credit bid? Their general alternatives are:
a. Support the transaction through voting and lock-up agreements binding support for the sale. This would be an indication of an adequate process.
b. Merely had advisors observing the process but no formal commitment. The determination of adequacy needs to be analyzed more specifically as to good faith, fairness and thoroughness.
c. Objecting to sale saying it was not a fair process or value is too low. This could be an indication of an inadequate process or the objectors could be trying to extract nuisance value in the sale process.
d. Asserting their right to credit bid (which may scare off potential buyers). This scenario needs to be analyzed specifically as to good faith, thoroughness and fairness.

15. Are their critical aspects of the sale that are beyond the seller's control?

Answers to this question can help understand if extenuating circumstances might make an otherwise inadequate process seem more adequate. Examples of things not within the seller's control are: union approval, regulatory approval, vendor approval, and customer approval.

E. Negotiation

Analyzing the interaction between the seller and prospective purchasers during the negotiation stage can yield insight regarding the competitiveness of the sales process. The following questions focus on the interaction during this phase of the sales process and how actions or inactions during this phase can identify the aspects of competition, fairness, good faith and thoroughness.

1. What evidence is there that the sellers attempted to get parties to improve their proposals?

Typically in a competitive bidding process investment bankers will tell buyers if they are in a position to win or not and might describe what changes must be made to the bid in order to remain in contention in the bidding process, e.g. increase the bid by 10%, and/or change the survival period for representations and warranties. Facilitating competitive bidding by negotiating with bidders shows competition and is also an indicator of a good faith effort.

2. Did the sellers have time and leverage to negotiate the proposal?

The time required to negotiate a proposal will vary with each sales process, however it is within the capabilities of those having the requisite skill in the art to determine if sufficient time was available to the sellers to negotiate. Knowing if the seller had ample time to negotiate the best price, or for whatever reason had insufficient time for such negotiation, might help explain why a process with poor results (i.e. low value) could still be adequate.

3. How many parties expressed interest in a transaction?

Generally, the larger the number of parties that express interest in participating in the transaction, the more competitive the process is likely to be. Competition often results in greater pressure on the target to conduct a good faith sale process. It can be appreciated that this determination is well within the capabilities of those skilled in the art.

4. What parties were involved in communicating with the prospective buyers?

Generally investment bankers are more experienced in company sales than management of the company itself. Also, investment bankers can be more subjective and are less likely to have a personal agenda versus a manager. Thus investment banker communication would be an indicator of a good faith effort. Further, in the case of a sale in bankruptcy, the target and its bankers should have their own or supplemental legal expertise experienced in handling sales of this matter in order to demonstrate good faith and thoroughness.

5. How many rounds of bidding occurred and did the proposals improve or not?

In most processes there is at least one round where all prospective purchasers are invited to submit proposals. The seller than selects finalists and asks them to improve or otherwise clarify their bids for a final selection. Sometimes at the “final” selection, the seller will tell the winning bidder to complete their documentation but not tell any other bidder yet that they did not win (in the event first place becomes or unreasonable in demands or is otherwise unable/unwilling to close). Accordingly, if all bidders were afforded a chance to improve their bids, this points to a level playing field during the bidding process and provides the opportunity for competition.

6. How did the seller's circumstances change during the solicitation process?

If during the negotiation process the seller's circumstances changed such that the value of the target significantly increased, a lack of disclosure would indicate a lack of good faith and that the process was not adequate. Timely disclosure to potential buyers of changed circumstances is a demonstration of good faith. Who is told and when is an indicator of fairness.

7. Was there a sense in the market that multiple parties were participating in the process?

As noted above, the presence of multiple bidders typically provides a sentiment of a good faith effort. Moreover, knowing other bidders are participating in the sales process would most likely cause the bidders that are serious about purchasing the property to submit more competitive (i.e. higher) bids—which necessarily produces an adequate process. Accordingly a sense of multiple parties is an indicator of an adequate process.

8. Did the media speculate about the identity or terms of potential buyers?

Fairness in this situation depends on the reputation of the potential buyers. For example, if there is a perception in the marketplace that the potential buyers are weak, then other purchasers may be attracted to overbid weaker parties. This situation could then result in a more adequate sale process as competition becomes more vigorous.

9. If an insider of the target is trying to buy the target, how was information flow about the process managed by the sellers?

The intent of this query is to determine the fairness of the process by examining if all potential purchasers received the same amount and detail of information, including the insider. As is known, equal knowledge of the subject property among the potential purchasers is necessary for a fair sale process. An insider receiving information on the status of other bidders' proposals can be detrimental to competition.

10. In general, was the value of the company increasing or decreasing through the solicitation process?

This question can be used as in conjunction with disclosure on changing circumstances to determine whether competition should be increasing or decreasing.

11. Did the market know or expect insiders to be bidders?

Knowledge of potential purchasers who are also insiders can chill prospective bidders, and since more bidders necessarily result in a more fair process, chilling the bidding process can inhibit the ability to conclude the process is competitive.

12. Did third parties express concern about the fairness of the process?

Answers to this question comment on the perception of fairness of the process, and as mentioned above, a process that is perceived to be unfair is predisposed to producing results that are not indicative of market value.

F. Execution

Execution refers primarily to the activities of the party selling the target company. The phases of the execution may be generally categorized as preparation for sale, identifying and soliciting buyers, facilitating buyer due diligence, guiding buyers to prepare preliminary bids, negotiating final bids, transaction documentation and consummation.

1. How rigorous was follow-up with buyers?

The follow-up stage of the transaction describes the seller's response to the prospective purchaser's requests for supplemental data or other questions about the property and/or the transaction itself. Prompt and attentive responses to the purchaser's inquiries generally enhances the ultimate bid figures and in turn suggests a more thorough and good faith effort.

2. How promptly was the response to supplemental information requests??

Promptness and thoroughness in responding to supplemental information requests supports the thesis of an adequate process. Providing only certain parties with supplemental information or slowing their access to supplemental data can be an indication of an unfair process and dampen competition.

3. How knowledgeable were the professionals conducting the sale process regarding issues surrounding the transaction?

This question specifically queries the experience of the particular sales personnel in mergers and acquisitions or restructuring. In particular, the historical experience of completing transactions and familiarity with the issues presented in the particular transaction can be relevant to determining the ability of the seller to make a good faith effort by accommodating buyers on transaction structure and process

4. Could the results of the auction be reconciled?

By examining the purchaser's log, one should be able to ascertain the perception of the target company in the minds of the potential purchasers. For example, if the larger strategic purchaser believed the target company is too small (in a concentrated industry) then the most likely candidates would be smaller companies; but financing for these parties may be an issue. There is often some consistency in why bidders do not proceed. It then becomes fact dependent to determine if why they did not proceed was a good reason (i.e. not due to lack of fairness, good faith or thoroughness in the process) instead of a reason due to the process being flawed (e.g. a process lacking in good faith, perhaps where management is not cooperative in information requests to buyers who are perceived to be likely to terminate many of the employees to take advantage of synergies).

5. Was the Information Memorandum professionally prepared?

The information memorandum is usually prepared by the seller's investment banker and as its name suggests contains pertinent financial information concerning the subject property. To satisfy the criteria of professionally prepared, it is not necessary that a person dedicated to preparing such documents be used, however the content, scope, and presentation of the memorandum must satisfy expected norms to be considered as being professionally prepared. A memorandum that does not adequately address the important aspects of the target company has overt omissions, or multiple typographical errors, would be considered as unprofessional. An unprofessionally prepared information memorandum can often lower the prospective bidder's interest thereby depressing an ultimate sales price, which leads to an unfair result. Similarly, the process is less meaningful (and indicates lack of good faith and thoroughness) if an executive of the seller merely refers the potential buyers to public SEC filings. In this scenario the buyer is not provided the comfort that a sale is likely to occur.

6. Were parties conducting the process able to adapt to market and other changes?

Market changes might include a change in the pricing of raw materials, such as for a steel producer, or a price change in commodities, such as fuel for an airline. Significant market changes typically warrant new projections and possibly rebidding is necessary to establish good faith and foster competition.

7. Were the parties who conducted the process generally perceived to be trust-worthy and working to explore the highest and best proposal?

Again, a perception that the process will be conducted in a good faith manner is generally more enticing to purchasers, and encourages the bids made to be more competitive. Thus a competitive process enhances the chances that the process is adequate and will yield a true indication of market value.

8. How much time and attention was devoted to each particular buyer by the parties soliciting, structuring and negotiating the transaction?

Here the focus is on the percentage of time and attention devoted to specific purchasers as well as what individual was assigned to the purchaser. For example, if an experienced staffer was devoted to a single prospective purchaser, whereas junior or less experienced persons were assigned to other purchasers, this is one way that the process can be skewed in favor of that particular purchaser. Thus in a fair process, not only is the time percentage of attention devoted to each purchaser important, but also the type of attention given each purchaser.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, the present method can be accomplished individually, or within a processor, such as a computer, where the commands made to the processor are included therein or supplied by external software applications. These and other similar modifications will readily suggest themselves to those skilled in the art, and are intended to be encompassed within the spirit of the present invention disclosed herein and the scope of the appended claims.

What is claimed is:

1. A method of evaluating the merger and acquisition of an entity comprising:
(a) evaluating the potential purchasers of the entity;
(b) analyzing dissemination of information about the entity;
(c) appraising the time frames surrounding the merger and acquisition sequence;
(d) investigating circumstances surrounding the transfer of possession of the entity;
(e) evaluating the facts surrounding the negotiation process; and
(f) assessing actions occurring during the execution of the merger and acquisition.

2. The method of claim 1, wherein step (a) comprises determining:
(i) the basis for selecting the original list of potential buyers;
(ii) the treatment for parties expressing unsolicited interest;
(iii) if a public announcement regarding the potential sale of the company;
(iv) if the sale process known generally by industry participants;
(v) if the sale generally known by other investment bankers;
(vi) if any logical potential buyers were not approached and why;
(vii) if a Buyers Log or comparable description of the timing and detail of the sale process with potential buyers existed;
(viii) if the right individuals at the firms approached;
(ix) if sufficient follow up with the parties was conducted;
(x) reasons for logical parties not pursuing a transaction;
(xi) the reason for passing over something the debtors could have rectified to make the process more competitive;
(xii) what portion of potential buyers did the debtors obtain closure; and
(xiii) if the results of the process be explained or reconciled.

3. The method of claim 1, wherein step (b) comprises determining:
(i) if the information available to potential buyers was provided pursuant to a reasonable confidentiality agreement;
(ii) if the information provided was adequate for a company to make an investment decision;
(iii) if the information included a professionally prepared information memorandum;
(iv) if the information easily accessible;
(v) if the information up to date;
(vi) if potential bidders were informed of updates to the information;
(vii) if financial projections were available and if the projections were realistic and if any critical assumptions were substantiated;
(viii) if the information positioned the entity in a favorable light;
(ix) if there was an opportunity to clarify questions and ask additional questions;
(x) if adequate information was available for parties to prepare schedules t o a purchase agreement; and
(xi) if risks to the transaction existed which could not be quantified.

4. The method of claim 1, wherein step (c) comprises determining:
(i) if adequate time was available to negotiate a confidentiality agreement;
(ii) if adequate time existed to review the information available;
(iii) if adequate time existed to prepare a bid;
(iv) how the time allowed for the acquisition of the entity compared to acquisition processes for other companies in the same industry as the entity;
(v) how the timing of the acquisition of the entity compared to sales of similar bankrupt entities or sales of other entities with comparable issues and complexity;
(vi) if any seasonal issues existed that could affect the marketing process.
(vii) if cyclical issues existed that could impact ability of strategic buyers to consummate a transaction;
(viii) if any part of the solicitation conducted during a period when other transactions in the marketplace were cancelled;
(ix) if any parties in other similar transactions invoked material adverse change clauses to cancel their obligations;
(x) if any timing constraints existed that were beyond the control of the party selling the entity that drove the timing of the sale process.

5. The method of claim 1, wherein step (d) comprises determining:
(i) if the seller of the entity can describe a way by which to deliver the asset to a potential buyer;
(ii) if the acquisition process is likely to involve litigation;
(iii) if process exists to deliver the asset more consensually;
(iv) if circumstances exist that might limit the resources a potential buyer may spend investigating an acquisition;
(v) if there a reserve price for the entity and if it is elastic;
(vi) if creditors or other constituencies were included in the solicitation process;
(vii) if previous attempts to sell the entity had occurred and the results of those attempts;
(viii) if the criteria for evaluating proposals was clear to potential buyers;
(ix) the likely timing to consummate an acquisition;
(x) the level of intensity with which the seller of the entity negotiated the sale terms;
(xi) if the market was concerned about the prospect of a bid by insiders;
(xii) if the seller of the entity was able to satisfy market concerns about the process being a level playing field;
(xiii) if the seller of the entity had any negotiating leverage with potential buyers;
(xiv) the position that secured lenders had taken regarding a credit bid; and
(xv) if critical aspects of the sale were present that were beyond the control of the seller of the entity.

6. The method of claim 1, wherein step (e) comprises determining:
(i) if the sellers of the entity attempted to get parties to improve their proposals;
(ii) if the sellers of the entity had time and leverage to negotiate the proposal;
(iii) how many parties expressed interest in a transaction;
(iv) what parties were involved in communicating with the prospective buyers;
(v) how many rounds of bidding occurred and did the proposals improve or not;
(vi) how did the circumstances of the seller of the entity change during the solicitation process;
(vii) if there was a belief by individuals in the industry of the entity that multiple parties were participating in the process;
(viii) if any press speculation was evident regarding the identity or terms of potential buyers;
(ix) how the information concerning the acquisition was administered by the sellers of the entity, if one of the buyers was an insider;
(x) if the value of the entity increased or decreased through the solicitation process;
(xi) if individuals in the industry of the entity knew or expected insiders to be bidders; and
(xii) if third parties expressed concern about the fairness of the process.

7. The method of claim 1, wherein step (f) comprises determining:
(i) how rigorous was any follow-up with buyers by the sellers of the entity;
(ii) how prompt were responses for additional data made;
(iii) how knowledgeable were the professionals conducting the sale process regarding acquisitions, industry, and transaction specific issues;
(iv) could the results of the acquisition be reconciled;
(v) if an Information Memorandum was prepared, was it professionally prepared;
(vi) were parties conducting the process able to adapt to market and other changes;
(vii) were the parties who conducted the process generally perceived to be trust-worthy and working to explore the highest and best proposal; and
(viii) how much the parties soliciting, structuring and negotiating the transaction devoted time and attention to each particular buyer.
